(19) United States
(12) Patent Application Publication
(10) Pub. No.: US 2019/0050195 A1
(43) Pub. Date: Feb. 14, 2019

(54) OUTPUT PROVISION BASED ON GAZE DETECTION

(71) Applicant: Lenovo (Singapore) Pte. Ltd., Singapore (SG)

(72) Inventors: Jonathan Gaither Knox, Morrisville, NC (US); Russell Speight VanBlon, Raleigh, NC (US); Ryan Charles Knudson, Durham, NC (US); Roderick Echols, Chapel Hill, NC (US)

(21) Appl. No.: 15/676,246

(22) Filed: Aug. 14, 2017

(51) Int. Cl. G06F 3/16; G06K 9/00; G06F 9/44

(52) U.S. Cl. CPC G06F 3/167; G06F 9/4446; G06K 9/00604

(57) ABSTRACT

One embodiment provides a method, including: receiving, at an information handling device, an indication to provide audible output to a user; detecting, using at least one image sensor, a user gaze from the user at a predetermined location; and providing, responsive to detecting the user gaze at the predetermined location, the audible output. Other aspects are described and claimed.

### BACKGROUND

Digital assistants employed on information handling devices (“devices”), for example smart phones, tablet devices, smart speakers, laptop and personal computers, and the like, may be capable of providing various types of output to a user (e.g., alerts, notifications, received messages, etc.). The output may be provided using at least one of a variety of different types of output methods (e.g., audible output, visual output, etc.), and may be provided automatically, without receiving any user command input to provide output.

### BRIEF SUMMARY

In summary, one aspect provides a method, comprising: receiving, at an information handling device, an indication to provide audible output to a user; detecting, using at least one image sensor, a user gaze from the user at a predetermined location; and providing, responsive to detecting the user gaze at the predetermined location, the audible output.

Another aspect provides an information handling device, comprising: at least one image sensor; a processor; a memory device that stores instructions executable by the processor to: receive an indication to provide audible output to a user; detect a user gaze from the user at a predetermined location; and provide, responsive to detecting the user gaze at the predetermined location, the audible output.

A further aspect provides a product, comprising: a storage device that stores code, the code being executable by a processor and comprising: code that receives an indication to provide audible output to a user; code that detects a user gaze from the user at a predetermined location; and code that provides, responsive to detecting the user gaze at the predetermined location, the audible output.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing audible output to a user based on gaze detection.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) responsive to receiving an indication to provide output (e.g., a user input requesting output, an alert, a notification, a received message, an incoming call, etc.).

Conventionally, digital assistants provide output once an indication to provide output is received. As such, conventional digital assistants do not determine whether a user is actually paying attention to the information that is being provided. For example, responsive to receiving a notification that a user's business meeting has been rescheduled, a conventional digital assistant may immediately provide audible output of that information to a user. However, if the user is engaged in an activity (e.g., talking to another individual, watching television, etc.) they may miss the important message. Additionally, conventional digital assistants are unable to determine whether a user has missed a message and therefore take no additional action (e.g., replay the message, etc.) to ensure that the message is actually communicated to the user.

An existing solution may identify that a user is engaged in a conversation and may wait for a conversational pause, or other non-interrupting moment, to provide information associated with the indication. However, this solution suffers from the same faults as other conventional digital assistants because the digital assistant does not determine if the user is engaged with the digital assistant when the interjection occurs.

Accordingly, an embodiment provides a method for providing audible output responsive to detecting a user's gaze at a predetermined location. In an embodiment, an indication to provide audible output to a user may be received at an information handling device. An embodiment may then determine whether a user's gaze is detected at a predetermined location. In an embodiment, the predetermined location may be at least a portion of the information handling device (e.g., a display screen of the information handling device, etc.) a digital assistant is disposed on (e.g., smart phone, tablet, etc.) or another device (e.g., smart speaker, etc.) that communicates output from the digital assistant. Responsive to detecting a user's gaze at a predetermined location, an embodiment may provide output (e.g., audible output communicating details associated with the indication, etc.). Such a method may enable devices to only provide informational output when a determination has been made that a user is paying attention to the device so that the user does not miss important information.

The illustrated example embodiments will be best understood by reference to the figures. The following description is intended only by way of example, and simply illustrates certain example embodiments.

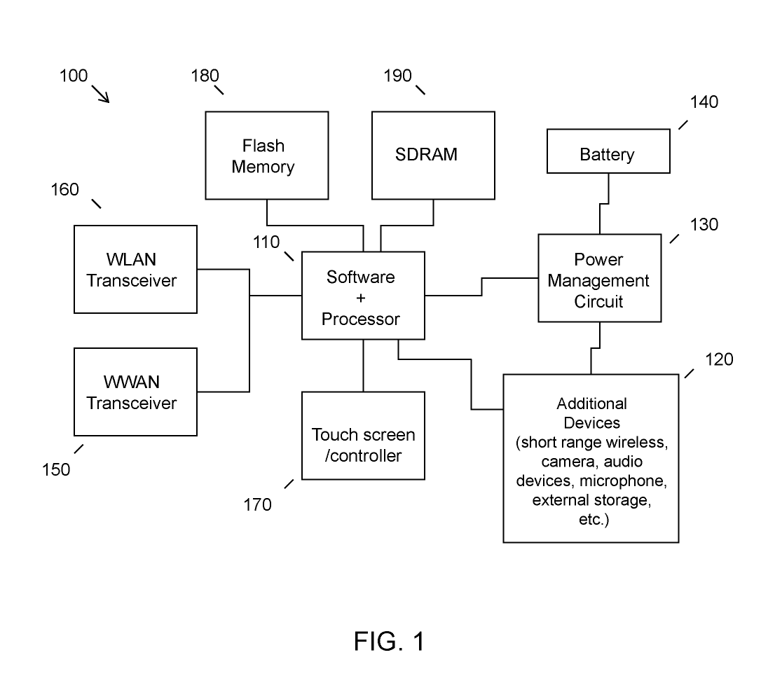

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes a touch screen 170 for data input and display/rendering. System 100 also typically includes various memory devices, for example flash memory 180 and SDRAM 190.

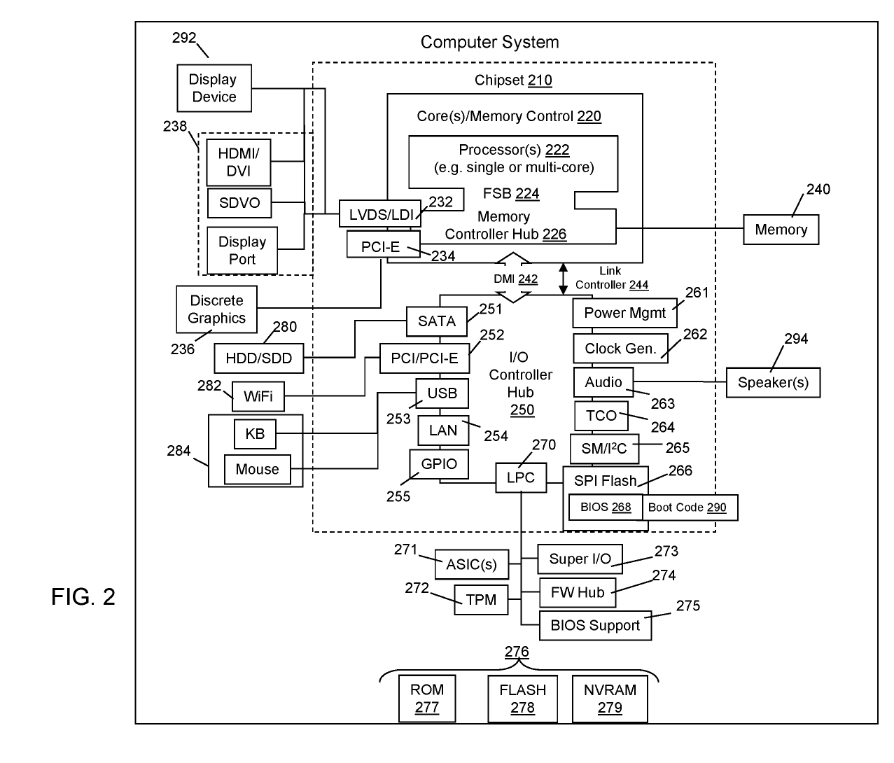

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

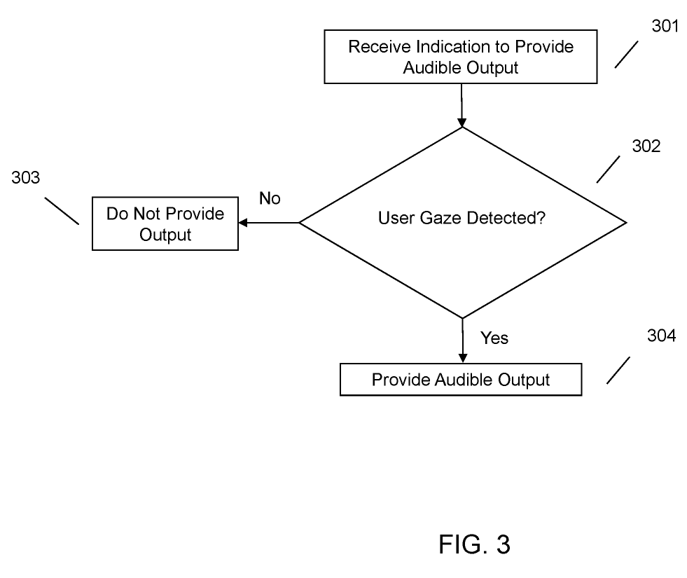

Referring now to FIG. 3, an embodiment may provide audible output to a user based on a detected location of a user's gaze. At 301, an embodiment may receive an indication to provide audible output to a user. In an embodiment, the indication may be any indication received by a digital assistant to provide information to a user. For example, the indication may be associated with an alert (e.g., that a user has a meeting in 15 minutes, etc.), a notification (e.g., that a scheduled meeting has been moved to a different time, etc.), a received message (e.g., an email, a text message, a voice message, etc.), and the like. The indication may also include an indication that a response should be provided. For example, if a user has provided a query input, an embodiment may process and analyze the query input in order to provide an output responsive to the query input. The determination that this output is ready for provision to a user may be the indication to the digital assistant that audible output should be provided.

At 302, an embodiment may detect whether a location of user's gaze is at a predetermined location. In an embodiment, the user's gaze may be detected by a gaze detection device (e.g., an image sensor such as a camera, etc.). In an embodiment, the gaze detection device may be integral to the information handling device. For example, a smart phone may be disposed with a camera capable of capturing image data associated with a user. Alternatively, the gaze detection device may be disposed on another device and may transmit detection data to the information handling device. For example, images of a user may be captured by a dedicated, standalone camera and then subsequently transmitted to another device (e.g., to a user's smartphone for processing, etc.). Detection data may be communicated from other sources to the information handling device via a wireless connection (e.g., using a BLUEOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the gaze detection device may be configured to continuously receive image input data by maintaining the gaze detection device in an active state. The gaze detection device may, for example, continuously detect image data even when other sensors (e.g., microphones, light sensors, speakers, other cameras, etc.) associated with the information handling device are inactive. Alternatively, the gaze detection device may remain in an active state for a predetermined amount of time (e.g., 30 minutes, 1 hour, 2 hours, etc.). Subsequent to not detecting user image data during this predetermined time window, an embodiment may switch the gaze detection device to a power off state. The predetermined time window may be preconfigured by a manufacturer or, alternatively, may be configured and set by one or more users.

In an embodiment, a predetermined location may correspond to a location of a user's gaze that signifies that a user is engaged with and/or capable of perceiving information provided by a digital assistant. For example, the predetermined location may include a portion of the device, for example, a display screen associated with a device, a location of the gaze detection device, a location of an output device associated with the device (e.g., speakers, etc.), and the like. The predetermined location may also be a location on or around the user. For example, the predetermined location may be a user's body part or a certain location in a room. The predetermined location may be preconfigured by a manufacturer or, alternatively, may be configured and set by one or more users.

Responsive to detecting, at 302, that a user's gaze is detected at a predetermined location, an embodiment may provide, at 304, audible output. In an embodiment, the audible output may be provided through an output device that may be integral to the device or may be located on another device. In the case of the latter, the output device may be connected via a wireless or wired connection to the device. For example, a smart phone may provide instructions to provide audible output through an operatively coupled smart speaker. In an embodiment, the output may be audio output, visual output, a combination thereof, or the like. For simplicity purposes, the majority of the remaining discussion will involve audible output that may be provided by an audible output device (e.g., a speaker, another audible output device, etc.) operatively coupled to a digital assistant. However, it should be understood that generally any form of output may be provided. In an embodiment, the audible output may be provided through a speaker, another output device, and the like.

In an embodiment, the audible output may be provided based on detecting that the user gaze is at a predetermined location for a predetermined amount of time (e.g., 2 seconds, 5 seconds, etc.). For example, an embodiment may provide output when it has determined that a user has continuously looked at a display screen associated with a device comprising a digital assistant for 3 seconds. In an embodiment, the predetermined amount of time may be pre-configured by a manufacturer or may be set by a user. In another embodiment, audible output may be provided during a duration of user gaze detection at the predetermined location. For example, an embodiment may begin to provide output when a user looks at a display screen but stops providing output when a user gaze is no longer detected at the display screen or another predetermined location.

In an embodiment, a portion of the information associated with the indication may be provided prior to detecting user gaze at a predetermined location. For example, an embodiment may audibly provide, prior to detecting user gaze at a predetermined location, a short message communicating to the user that an email has just been received (e.g., “You just got an e-mail”, etc.). Responsive to detecting a user's gaze at a predetermined location, an embodiment may audibly provide another portion of the information associated with the indication (e.g., an additional or remaining portion of the email message, etc.). Such embodiments enable a user to quickly attain an idea of the content of the output so that they can decide whether they want to receive the remaining portions of the output.

In an embodiment, a priority level of the output may be determined. The priority level may correspond to how important or time-sensitive information associated with the output may be to a user. In an embodiment, priority levels may be pre-assigned and attached to different outputs and may be dependent upon, for example, output type (e.g., alert, notification, text message, etc.), output affiliation (work-based output, personal output, etc.), the sender of information associated with the output (boss, spouse, etc.), and the like. For example, all work-based output (e.g., meeting alerts, scheduling notifications, etc.) may be assigned a high priority level whereas all personal output (e.g., messages from friends, etc.) may be assigned a standard priority level. In an embodiment, priority levels may be assigned by the manufacturer or may be set by a user. In another embodiment, priority levels may be determined and assigned dynamically. For example, an embodiment may analyze the content of information associated with the output (e.g., using one of a variety of content analysis techniques known in the art, etc.) and dynamically determine whether the output is high priority output.

Responsive to determining that an output is associated with a high priority level, an embodiment may immediately provide the output to a user. In an embodiment, output associated with a high priority level may be provided to a user irrespective of the location of the user's gaze. For example, if an embodiment determines that a piece of output is high priority output but does not detect a user's gaze at a predetermined location, an embodiment may nonetheless provide the output to the user.

Responsive to detecting, at 302, that a user's gaze is not detected at a predetermined location, an embodiment may not, at 303, provide audible output. An embodiment may, however, later provide audible output when a user's gaze is detected at a predetermined location. Methods may be used to draw a user's attention to a predetermined location, or, at least, alert the user that a digital assistant has output to provide.

In an embodiment, a notification may be provided responsive to receiving the indication to provide output. The notification may serve to notify a user that there is information ready to be output to a user and may be provided regardless of whether a user's gaze is detected at a predetermined location. The notification may be, for example, a blinking light, a stagnant light (i.e., a light that does not blink and remains on), an audible notification (e.g., a beep, another sound, etc.), a visual notification (e.g., a message, picture, or other visual notification provided on a display associated with the device), and the like. In an embodiment, the notification may be on-going until a user explicitly requests the digital assistant to provide the output. In another embodiment, a notification may cease when a user's gaze is detected at a predetermined location for a predetermined amount of time.

In an embodiment, the notification may be adjusted based upon a determined priority level. The adjustment of a notification may serve to better alert users to high priority outputs. For example, for output determined (e.g., using the methods described above) to be high priority (e.g., a time-sensitive work notification, a text message from a spouse, etc.), an embodiment may perform at least one of the following functions: increase the frequency of a blinking light, increase the intensity of a stagnant light, increase the decibel level of the audible notification, provide a more eye-catching visual notification (e.g., by using brighter colors, animations, etc.), and the like.

The various embodiments described herein thus represent a technical improvement to conventional audible output provision techniques. Using the techniques described herein, an embodiment may receive an indication to provide audible output to a user. An embodiment may determine whether a user's gaze is fixed on a predetermined location, and responsive to detecting the user gaze at the predetermined location, an embodiment may thereafter the audible output. Such techniques ensure that a device does not output information when a user is not listening or paying attention.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to provide audible output to a user;
detecting, using at least one image sensor, a user gaze from the user at a predetermined location; and
providing, responsive to detecting the user gaze at the predetermined location, the audible output.

2. The method of claim 1, wherein the providing comprises providing the output based on detecting the user gaze at the predetermined location for a predetermined amount of time.

3. The method of claim 1, wherein the providing comprises providing output during a duration of user gaze detection at the predetermined location.

4. The method of claim 1, wherein the predetermined location comprises at least a portion of the information handling device.

5. The method of claim 1, further comprising providing, prior to the detecting, at least a portion of the audible output.

6. The method of claim 5, wherein the audible output provided responsive to detecting the user gaze at the predetermined location comprises another portion of the output, different from the at least a portion of the output.

7. The method of claim 1, further comprising determining, using a processor, a priority level of the output and providing, irrespective of detection of the user gaze, the output based on determining that the priority level is associated with a high priority level.

8. The method of claim 1, further comprising providing, responsive to receiving the indication, a notification.

9. The method of claim 8, wherein the notification is at least one notification selected from the group consisting of a blinking light, a stagnant light, an audible notification, and a visual notification provided on a display associated with the information handling device.

10. The method of claim 8, wherein the notification is adjusted based upon a determined priority level of the output.

11. An information handling device, comprising:
at least one image sensor;
a processor;
a memory device that stores instructions executable by the processor to:
receive an indication to provide audible output to a user;
detect a user gaze from the user at a predetermined location; and
provide, responsive to detecting the user gaze at the predetermined location, the audible output.

12. The information handling device of claim 11, wherein the instructions executable by the processor to provide comprise instructions executable by the processor to provide the output based on detecting the user gaze at the predetermined location for a predetermined amount of time.

13. The information handling device of claim 11, wherein the instructions executable by the processor to provide comprise instructions executable by the processor to provide output during a duration of user gaze detection at the predetermined location.

14. The information handling device of claim 11, wherein the predetermined location comprises at least a portion of the information handling device.

15. The information handling device of claim 11, wherein the instructions are further executable by the processor to provide, prior to the instructions executable by the processor to detect, at least a portion of the audible output.

16. The information handling device of claim 11, wherein the instructions are further executable by the processor to determine a priority level of the output and provide, irrespective of detection of the user gaze, the output based on determining that the priority level is associated with a high priority level.

17. The information handling device of claim 11, wherein the instructions are further executable by the processor to provide, responsive to receiving the indication, a notification.

18. The information handling device of claim 17, wherein the notification is at least one notification selected from the group consisting of a blinking light, a stagnant light, an audible notification, and a visual notification provided on a display associated with the information handling device.

19. The information handling device of claim 17, wherein the notification is adjusted based upon a determined priority level of the output.

20. A product, comprising:
a storage device that stores code, the code being executable by a processor and comprising:
code that receives an indication to provide audible output to a user;
code that detects a user gaze from the user at a predetermined location; and
code that provides, responsive to detecting the user gaze at the predetermined location, the audible output.
